(19) United States
(12) Patent Application Publication
(10) Pub. No.: US 2025/0020913 A1
(43) Pub. Date: Jan. 16, 2025

(54) BEAM SCANNER

(71) Applicant: TRULIFE OPTICS LIMITED, London Greater London (GB)

(72) Inventor: Andrii VOLKOV, London Greater London (GB)

(73) Assignee: TRULIFE OPTICS LIMITED, London Greater London (GB)

(21) Appl. No.: 18/714,643

(22) PCT Filed: Nov. 1, 2022
(86) PCT No.: PCT/EP2022/080431

§ 371 Date: May 30, 2024

(30) Foreign Application Priority Data
Nov. 30, 2021 (GB) 2117284.6

(51) Int. Cl. G02B 26/10; G02B 26/08; G02B 27/01; G02B 27/09

(52) U.S. Cl. CPC G02B 26/105; G02B 26/0833; G02B 27/0172; G02B 27/0988; G02B 2027/0178

(57) ABSTRACT

The disclosure relates to a beam scanner system for a virtual retinal display. The beam scanner includes an optical baffle; and a micro scanning mirror The micro scanning mirror is located on an optical axis of a light source, and configured and arranged to rotate about an axis of rotation to reflectively scan the light beam between a first angular position and a second angular position. The optical baffle is positioned with respect to the micro scanning mirror to controllably block or pass the light beam as the micro scanning mirror moves between a first angular position and a second angular position.

### CROSS-REFERENCE TO RELATED APPLICATIONS

This application is a national stage application, filed under 35 U.S.C. § 371, of International Patent Application No. PCT/EP2022/080431, filed on Nov. 1, 2022, which claims priority to United Kingdom Patent Application No. 2117284.6, filed on Nov. 30, 2021, the entire contents of each of which is incorporated by reference herein in its entirety.

### BACKGROUND

### 1. Field of the Disclosure

The disclosure relates to a beam scanner system for a virtual retinal display. The disclosure also relates to a virtual retinal display (VRD) system comprising such a beam scanner system. The disclosure also relates to augmented reality (AR) displays, such as AR glasses or head-up displays, comprising such virtual retinal displays.

### 2. Description of the Related Art

All optical systems, of which beam scanners and virtual retinal displays are an example, using lenses or mirrors suffer from aberrations which cause light to spread out in space rather than be collimated or focused at a perfect point. There are two general classes of aberrations, namely chromatic aberrations and geometric aberrations (also known as monochromatic aberrations). Geometric aberrations arise in optical systems due to the geometries of the lens and/or mirrors used for refraction and reflection. There are several types of geometric aberrations, namely: spherical aberration, coma, astigmatism, field curvature and image distortion, collectively known as Seidel aberrations, and in off-axis systems such as beam scanners and/or virtual retinal displays, these aberrations tend to dominate at the edges of the image. Taking spherical aberrations as an example, marginal rays, that is non-paraxial rays, may have a different focal length (longer or shorter) than paraxial rays, as shown for example in FIG. 1a. In the context of beam scanners and virtual retinal displays geometric aberrations occur for individual rays making up an image and also across the whole field of view of an image and are particularly pronounced for non-paraxial or off-axis rays.

AR display systems may use holographic optical elements (HOEs) to direct light from a beam scanner or virtual retinal display to a user's eye. It is known however that HOEs are heavily asymmetric, that is they reflect light beams on the optical axis of a system to off the optical axis. In AR display systems it is known that geometric aberrations increase for light beams off axis as shown for example in FIG. 1a.

To overcome the problem of geometric aberrations it is also known to use aperture stops, such as an iris or a slit to block marginal rays and reduce geometric aberrations, as shown for example in FIG. 1b. Alternatively, it is known to reduce the spot size of the light source, such as a laser, to reduce aberrations. However, introducing aperture stops can cause unwanted diffraction effects and it is known that as the aperture gets smaller, or the spot size gets smaller, the diffraction effects increase. Diffraction effects are particularly pronounced for beam scanning projection systems such as VRD systems where the light beam spot size is small, typically 1.5 mm² or less. Therefore, optical designers need to balance reducing geometric aberrations against increasing unwanted diffraction effects. Additionally, in beam scanning projection systems, marginal (or non-paraxial rays) suffer from aberrations as described, however the edges of individual collimated beams in for example a VRD system may also suffer from unwanted geometric aberrations.

There is a need therefore to reduce unwanted geometric aberrations in beam scanning projection systems, such as VRDs, without unduly increasing unwanted diffraction effects. There is also a need to solve this problem in a low-cost way without unduly increasing the size and weight of such a beam scanning system, which typically rely on micro scanning mirrors with a reflective area substantially the same as the beam spot size, e.g. 1 to 1.5 mm². This size and weight issue is particularly important in AR applications which require small form factor components capable of being mounted on frames of AR glasses.

Furthermore, the balance between minimising geometric aberrations without unduly increasing diffraction effects is particularly relevant in the field of virtual retinal display systems utilising off axis holographic optical elements.

### SUMMARY

With the above issues in mind there is provided a beam scanner system for a virtual retinal display comprising: an optical baffle; and a micro scanning mirror; wherein the micro scanning mirror is located on an optical axis of a light source, and configured and arranged to rotate about an axis of rotation to reflectively scan the light beam between a first angular position and a second angular position; and wherein the optical baffle is positioned with respect to the micro scanning mirror to controllably vignette the light beam as the micro scanning mirror moves between a first angular position and a second angular position.

The optical baffle may be positioned with respect to the micro scanning mirror to partially obscure the light beam when the micro scanning mirror is at a first angular position and to fully transmit the light beam when the micro scanning mirror is in the second angular position.

The micro scanning mirror may be further configured and arranged to scan intermediate angular positions between the first and second angular positions. The intermediate angular positions may partially obscure the light beam and amount the light beam is obscured may be dependent the angular position of the micro scanning mirror.

The optical baffle may be positioned with respect to the micro scanning mirror to controllably vignette the light beam when the micro scanning mirror is at a first angular position and wherein the amount of vignetting of the light beam decreases as micro scanning mirror scans from the first angular position to intermediate angular positions between the first and second angular positions. The optical baffle may be positioned to provide pupil vignetting.

The optical baffle may comprise first and second distal ends, and the first distal end comprises a longitudinal edge. The longitudinal edge may linear or non-linear. The longitudinal edge may comprise a bevelled edge profile, wherein the bevelled edge profile is a knife edge profile. The optical baffle may be coated with an anti-reflection material, the anti-reflection material may be an optically absorptive material.

The optical baffle may be arranged with respect to the micro scanning mirror such that between 0 to 80% of the light beam is obscured when the micro scanning mirror scans between the first angular position and the second angular position.

The optical baffle may define an aperture, and the aperture mat be asymmetric with respect to the micro scanning mirror.

The beam scanner may comprise a plurality of said optical baffles arranged across the plane between the first angular position and the second angular position.

The beam scanner may further comprise a housing to which the micro scanning mirror is rotatably fixed, the housing may comprise an aperture and the optical baffle is arranged at one side of the aperture to define an aperture width.

There is also provided a virtual retinal display projector comprising the beam scanner system according to embodiments, and a light source. The light source may be an RGB diode laser or LED array and said micro scanning mirror may be micro-electromechanical (MEMS) scanning mirror.

There is also provided an augmented reality display system, comprising: the virtual retinal display projector according to embodiments, wherein the virtual retinal display projector is configured and arranged to direct the light beam to a holographic optical element. The augmented reality display system may further comprise a pair of smart glasses wherein the holographic optical element is combined with one or more lenses of the smart glasses.

### BRIEF DESCRIPTION OF THE DRAWINGS

So that the manner in which the features of the present disclosure can be understood in detail, a more particular description is made with reference to embodiments, some of which are illustrated in the appended figures. It is to be noted, however, that the appended figures illustrate only typical embodiments and are therefore not to be considered limiting of its scope. The figures are for facilitating an understanding of the disclosure and unless otherwise indicated are schematic only and are not necessarily drawn to scale. Advantages of the subject matter claimed will become apparent to those skilled in the art upon reading this description in conjunction with the accompanying figures, in which like reference numerals have been used to designate like elements, and in which:

FIG. 1a shows the concept of spherical aberrations.

FIG. 1b shows the concept of an aperture stop to reduce geometric aberrations.

FIG. 2a illustrates a schematic of a beam scanner system according to embodiments in first scan position.

FIG. 2b illustrates a schematic of a beam scanner system according to embodiments in intermediate scan position.

FIG. 2c illustrates a schematic of a beam scanner system according to embodiments in second scan position.

FIGS. 3a, 3b and 3c illustrate example optical baffle longitudinal profiles.

FIG. 4 illustrates a schematic of a beam scanner system and respective housing according to embodiments.

FIG. 5 illustrates a schematic of a virtual retinal display projector and holographic optical element according to embodiments.

FIG. 6 illustrates a schematic of an augmented reality display system according to embodiments.

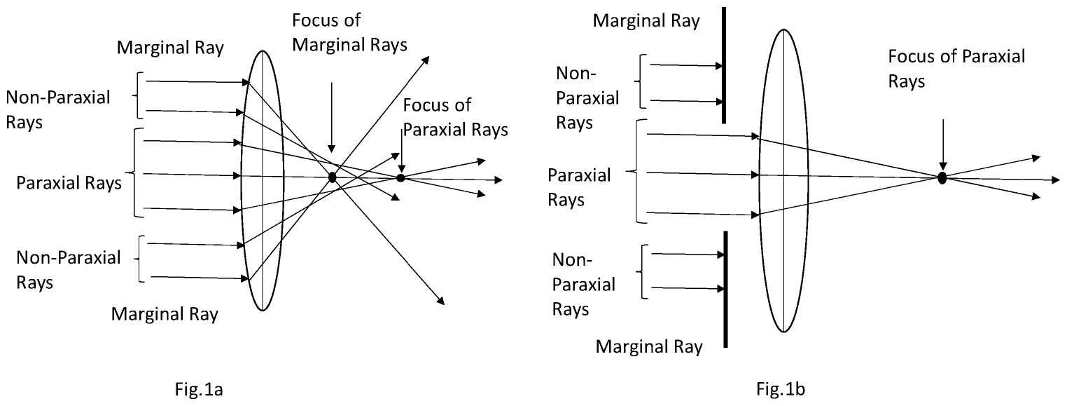

### DETAILED DESCRIPTION

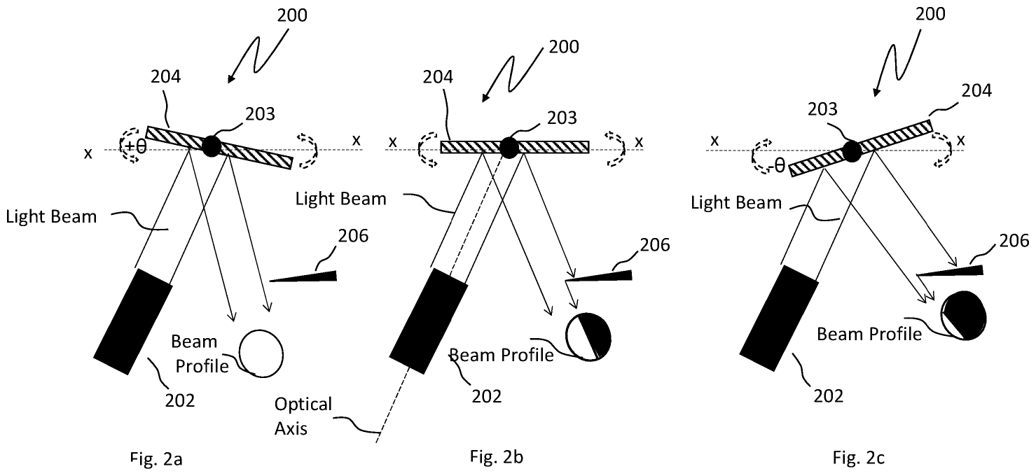

A beam scanner 200 according to an embodiment is illustrated in FIGS. 2a, 2b and 2c. In overview, the beam scanner 200 comprises a micro scanning mirror 204, and an optical baffle 206. The micro scanning mirror 204 is arranged to reflect light from a light source 202. The micro scanning mirror 204 comprises an axis of rotation 203 about which the mirror can rotatably pivot. The light source is aligned such that light therefrom is incident on the micro scanning mirror 204. Typically for example the light source may be aligned at 45 degrees to the micro scanning mirror 204.

Typically, the angular rotational range of the micro scanning mirror 204 may be up to +15 degrees from a horizontal axis x-x. This rotational range defines the limits of rotation of the micro scanning mirror described herein as first and second angular positions. FIG. 2b illustrates the micro scanning mirror 204 at an angular position θ of 0 degrees, that is the micro scanning mirror 204 is not rotated with respect to the horizontal axis x-x. FIG. 2a illustrates the micro scanning mirror 204 at a first angular position of +θ, where, taking the example above θ would be +15 degrees from the horizontal axis x-x. FIG. 2c illustrates the micro scanning mirror 204 at a second angular position of −θ and taking the example above θ would be −15 degrees from the horizontal axis x-x. This angular rotational range defines a maximum mechanical angular deflection range of the micro scanning mirror 204, which following the example given above would be 30 degrees. The micro scanning mirror may comprise a plane mirror surface and it follows therefore that the maximum optical reflection angle is two times the maximum mechanical deflection angle which defines a projection plane range of the micro scanning mirror 204.

The light source 202 may be any suitable light source, and by way of example, may comprise an array of low power RGB (red, green, blue) light sources such as laser diodes or LEDs to generate a collimated light beam. The collimated beam may have a beam diameter of, for example, approximately 1 mm. The light source 202 is arranged at an input side of the beam scanner 200 to direct the light beam onto the micro scanning mirror 204. The micro scanning mirror 204 is arranged to reflect the light beam and the mechanical deflection of the micro scanning mirror 204 results in the reflection of the light beam. It follows therefore that the projection plane range of the light beam corresponds to the projection plane range of the micro scanning mirror 204 thus defining a beam scanner 200 projection plane.

The optical baffle 206 is arranged at an output side of the beam scanner 200. The optical baffle 206 is arranged to partially block or obscure the light beam when the micro scanning mirror 204 is at a first angular position, and allow the light beam to pass, without obstruction then the micro scanning mirror is at a second angular position. In other words, the optical baffle 206 is aligned with respect to the micro scanning mirror 204, such the beam is not blocked either fully or partially, when the micro scanning mirror 204 is in a second angular position. When the micro scanning mirror 204 is in the first angular position the optical baffle 206 extends or impinges partially across the diameter of the reflected light beam. In this way, the operation of micro scanning mirror 204 in conjunction with the optical baffle 206 allows the light beam passing the optical baffle 206 to be controllably modulated dependent on the angular position of the micro scanning mirror 204. In the context of the present application, modulation may be understood to be a modulation of the amount of light passed or blocked by the optical baffle 206.

The extent of the beam blocking is illustrated in each of the beam profiles, inset to each of FIGS. 2a, 2b and 2c. For the beam profile of FIG. 2a the beam from the light source 202 is replicated by reflection from the micro scanning mirror 204 at the second angular position because the light beam is not incident on the optical baffle 206. The shape of the beam profile at the output side of the beam scanner 200 corresponds to the shape of the light beam profile from the light source 202. The skilled person will appreciate that there will be a range of angles of rotation over which the micro scanning mirror 204 where the light beam is not incident on the optical baffle 206.

For the beam profile of FIG. 2c the light beam from the light source 202, as reflected by the micro scanning mirror 204 at the first angular position, is partially incident on the optical baffle 206 such that part of the beam is blocked or obscured by an amount equal to the distance that the optical baffle 206 extends across the light beam reflected by the micro scanning mirror 204. When the micro scanning mirror 204 is at the first angular position, that is the maximum extent of angular rotation in the negative direction −θ, the proportion of the light beam incident on the optical baffle 206 will be at a maximum and the proportion of the beam profile passing the optical baffle will therefore be a minimum.

With reference to FIG. 2b, and the beam profile inset thereto, when the angular position of the micro scanning mirror 204 is intermediate to the first angular position and the second angular position, which in this example is aligned to the horizontal axis x-x, the amount of light incident on the optical baffle 206, will be less than the case for FIG. 2c and more than the case for FIG. 2a. In this way the skilled person will see that as the micro scanning mirror 204 rotates from the first angular position, through the intermediate position and including any subsequent intermediate positions, to the second angular position, the amount of light blocked by the optical baffle 206 will decrease from a maximum. Thus, the amount of light transmitted will increase as the micro scanning mirror 204 rotates to the second angular position.

Whilst the intermediate position illustrated in FIG. 2b corresponds to the axis x-x, the skilled person will appreciate that there will be infinite intermediate angular positions within the range of angular rotation of the micro scanning mirror 204.

In this way the beam scanner according to embodiments operates as a variable or adjustable optical slit, but rather than modulate the extent to which the beam is blocked, partially blocked or passed by the slit using costly, slow and bulky servo-motors, the beam is scanned relative to the stationary optical baffle 206 using the micro scanning mirror 204. In other words, the beam scanner 200 serves as a beam profiler or beam shaper.

The process of partially blocking a light beam is known as vignetting, whereby the beam brightness is reduced toward the periphery, in this case on the side of the light beam corresponding to the optical baffle 206. The amount of vignetting will therefore be more pronounced when the micro scanning mirror 204 is at the first angular position. In other words, the optical baffle 206 which is arranged with respect to the micro scanning mirror acts to vignette the beam as it scans to one side in one direction and may not vignette the beam or reduce the amount of vignetting as it scans to the other direction. The amount of vignetting will therefore be variable as the micro scanning mirror scans between the first angular position and the second angular position. In this way the beam scanner 200 according to embodiments may be considered to provide field dependent vignetting because the amount of vignetting is dependent on the angle of rotation (within the field of view) of the micro scanning mirror. This angular dependence of the amount of vignetting may be considered to be pupil vignetting.

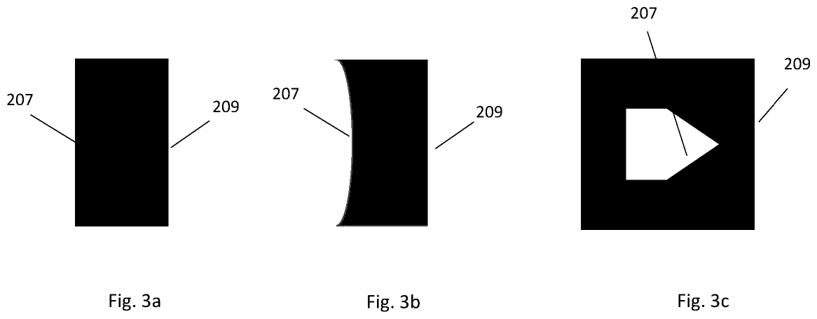

The optical baffle 206 may be any appropriate shape or geometry to partially obscure the light beam when the micro scanning mirror 204 is at the first angular position and positions intermediate to the first and second angular positions. The optical baffle 206 comprises first 207 and second 209 distal ends. The first end 207 comprises an edge running from top to bottom (as viewed in FIGS. 3a and 3b) which may be a longitudinal straight (or linear) edge as illustrated in FIG. 3a, or alternatively the first end may be a longitudinal curved (or non-linear) edge as illustrated in FIG. 3b. The skilled person will appreciate however, that the first end 207 may be any appropriate shape, such as V-shaped, U-shaped, S-Shaped, or freeform curve depending on the specific nature of the optical design. As illustrated in FIG. 3c, the first end 207 may define one side of the asymmetric aperture.

In the case of one-dimensional scanning mirrors, that is mirrors which rotate about one axis (as described above), the amount of vignetting will be constant for a specific angle of rotation. However, in the case of two-dimensional scanning mirrors (also known as tip-tilt mirrors), that is mirrors which can rotate about two axes (horizontal and vertical), the amount of vignetting the will vary for a specific first axis (e.g. horizontal) angle of rotation dependent on a specific second (e.g. vertical) angle of rotation. In this case therefore, the optical baffle provides for field dependent vignetting, where the amount of vignetting is dependent on both the vertical and horizontal angles of rotation of a two-dimensional micro scanning mirror.

The first end 207 of the optical baffle 206 may comprise an edge profile which is arranged to intersect the light beam. This edge profile may be squared or rounded. Preferably, the edge profile may have an angled or bevelled profile to minimise scattering of the light beam when incident thereon and or to minimise unwanted back reflections to the micro scanning mirror 204. In this regard the optical baffle 206 may be a so-called knife edge.

The edge profile of the optical baffle 206 may be angled such that one side of the edge is substantially perpendicular to the optical axis and an opposing side is angled to be less than substantially perpendicular to the optical axis to minimise back reflections to the micro scanning mirror.

The optical baffle 206 may also optionally be coated with an antireflection (AR) coating to minimise unwanted reflections back to the micro scanning mirror 204. The AR coating may be any appropriate coating such as an optically absorptive material, for example a black anodised coating.

The skilled person will appreciate that the optical baffle 206 acts as an aperture and that the aperture is effective on one side of the periphery of the light beam when the beam is partially incident on the optical baffle 206 and as the micro scanning mirror 204 rotates to the first angular position. Further, because the aperture is effective on one side of the light beam, when the micro scanning mirror is at a first angular position and partially blocked and is not blocked when the micro scanning mirror 204 rotates to the second angular position as illustrated in FIG. 2a, the aperture may be considered to be an asymmetric aperture. The optical baffle 206 therefore blocks marginal rays on one side of the light beam and results in a gradual fading of the light beam at one side thereof (as illustrated the beam profiles FIGS. 2b and 2c) corresponding to the portion of the light beam blocked by the aperture. In other words, the arrangement of micro scanning mirror 204 and optical baffle 206 act to controllably aperture the light beam.

As the micro scanning mirror 204 rotates away from the first angular position towards the second angular position, through intermediate angular positions the amount of vignetting will decrease until the beam is no longer incident on the optical baffle 206. In other words, as the micro scanning mirror 204 rotates, less marginal rays of the light beam are blocked, and the effect of vignetting is reduced accordingly. When the micro scanning mirror 204 rotates to the second angular position and the light beam is no longer incident on the optical baffle 206 vignetting due to the optical baffle 206 will not occur or may be reduced compared to the first angular position. In this way, the skilled person will appreciate that the amount of vignetting is dependent on the angular position of the micro scanning mirror 204 and that the vignetting is asymmetric on one side of the beam only. It is therefore possible to implement variable vignetting of light beam from the light source reflected by the micro scanning mirror 204.

When the micro scanning mirror 204 rotates to the first angular position the amount of the light beam blocked by the optical baffle 206 should be no more than 80% for example, otherwise the beam brightness will be reduced to such an extent that image quality will be degraded. The skilled person will appreciate that any reduction in beam brightness may be compensated for by increasing electrical power input to the light source thereby increasing the brightness of the light beam from the light source. As the micro scanning mirror 204 rotates through the intermediate position to the second angular position the amount of the light beam blocked by the baffle will reduce, dependent on angular position, until the mirror reaches the second position. At the second position 0% of the beam will be blocked. The skilled person will appreciate therefore as the amount of beam blocking increases the geometric aberrations reduce.

Whilst, in the ideal case as described above it is preferable to allow a certain proportion of the light beam to pass the optical baffle 206 thereby vignetting the light beam as described above. However, the beam scanner 200 according to the present disclosure may also be arranged such that the light beam may be completely blocked when the micro scanning mirror 204 rotates to a further angular position past the second angular position. This has the effect of completely blocking the light beam which can be preferable to switching the light source 202 off in situations where it is desirable to avoid repeatedly powering the light source on and off. In this way it is possible to controllably modulate, block/partially block, or vignette the amount of the light beam passing the optical baffle as a function of the angular position of the optical baffle.

The skilled person will appreciate that the angular rotational range of the micro scanning mirror 204 as described above defines a field of view and that the optical baffle 206 limits the field of view on one side (when the micro scanning mirror is at the first angular position) but not on the other side (when the micro scanning mirror is at the second angular position).

By vignetting the light beam in this way, that is by field dependent vignetting, it is possible to reduce geometric aberrations. It is also possible to reduce geometric aberrations when the micro scanning mirror scans to one side of the optical axis without unduly increasing diffraction effects as it scans in the other direction.

Optionally, the beam scanner may comprise additional optics such as lenses, mirrors or beam splitters (not illustrated) placed at the output side of the beam scanner. The optical baffle may be arranged on or at the additional optics to provide the variable vignetting as described herein.

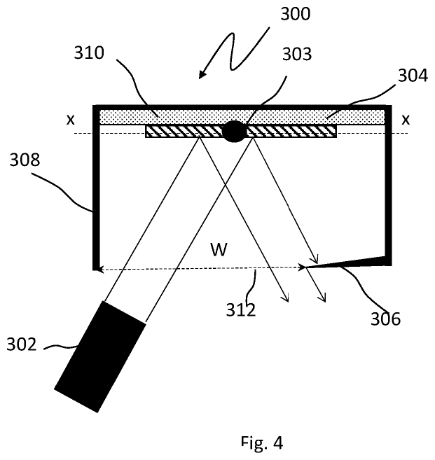

A beam scanner 300 of the type described above is also illustrated in FIG. 4. The beam scanner 300 comprises a micro scanning mirror 304, an optical baffle 306, a housing or package 308 and one or more support members 310. The micro scanning mirror 304 is arranged to reflect light from a light source 302 and the micro scanning mirror 304 comprises an axis of rotation 303 about which the mirror can rotate.

As with the arrangement of FIGS. 2a, 2b and 2c, the angular rotational range of the micro scanning mirror 304, may be for example up to +15° from the horizontal axis x-x. The light source 302, may comprise an array of low power RGB (red, green, blue) light sources such as laser diodes or LEDs to generate a collimated light beam, having a beam diameter of, for example, approximately 1 mm. The light source 302 is arranged at an input side of the beam scanner 300 to direct the light beam onto the micro scanning mirror 304. The optical baffle 306 is arranged at an output side of the beam scanner 300 to variably vignette the light beam as described in more detail above with respect to FIGS. 2a, 2b and 2c.

The micro scanning mirror 304 is rotatably mounted to the housing or package 308 by the one or more support members 310. The support members 310 are arranged such that the scanning mirror 304 may be controllably rotated about the axis of rotation 303 from a first angular position, through intermediate angular positions to a second angular position. The support members 310 may be torsion bars and the rotation of the mirror may be controlled by application of an electrical current as is known in the art of micro scanning or MEMS mirrors.

The housing 308 may encase or enclose the micro scanning mirror 304 and support member 310. The housing 308 may comprise an aperture or window 312, through which the light beam from the light source 302 may be directed into the housing and on to the micro scanning mirror 304. The light beam reflected from the micro scanning mirror 304 may also exit housing 308 through the aperture 312. The optical baffle 306 may be fixedly attached to the housing and may define the width, W of the aperture or window. The housing 308 may also support the optical baffle 306. The optical baffle 306 may be arranged with respect to the micro scanning mirror 304 in accordance with the arrangement described above with respect to FIGS. 2a, 2b and 2c to provide controllable vignetting. The optical baffle 306 may be formed of any appropriate material such as an optically absorptive material such as anodised or coated metal. The aperture or window 312 may be open (that is, it is not formed of any material) or it may formed of a transparent material such as a glass or polycarbonate material. In this case, the optical baffle 306 may be formed of an opaque material arranged on the transparent window material such. As before, the material by be any appropriate optically absorptive material. In this way the beam scanner according to this embodiment may be hermetically sealed. The operating principles of the beam scanner 300 are the same as those of the arrangement of FIGS. 2a, 2b and 2c described above.

The skilled person will appreciate that the angular rotational range, in the context of beam scanning systems described above may be any appropriate range and not necessarily limited to the examples given. The positive and negative values of angle of rotation are interchangeable and are merely given as an indication of off-axis (x-x) rotation. Any angular rotational range may be chosen dependent on the beam diameter, to provide no vignetting on the one side and an amount of vignetting on the other side, where the amount of vignetting is controllable.

The light source may be any appropriate RBG laser diode array such as that developed by EXALOS AG. The micro scanning mirror may be any appropriate mirror, such as micro-electromechanical mirrors (MEMS) developed by OQmented GmbH.

The beam scanner as described above may be used in applications such as virtual retinal display (VRD) projector systems. A VRD projector system, also known as a Retinal Scan Display (RSD) system or more simply a Retinal Projector (RP) system, is a display technology that rapidly scans or rasters a display image via an optical system onto the retina of a user's eye. VRD systems, enable users to see what appears to be a conventional display floating in their field of view in front of them. Such VRD systems are currently incorporated into so-called smart glasses to enable augmented reality where a virtual image is displayed to a user wearing the smart glasses. The scanning or rastering of the display image is achieved by using one or more beam scanners of the type described above.

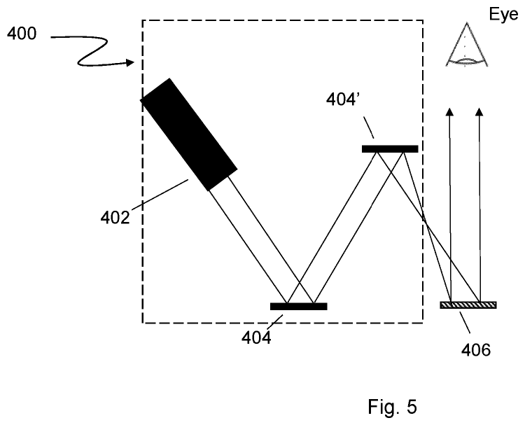

By way of example, a VRD projector system 400 is illustrated in FIG. 5, which comprises a light source 402, which can typically be a low power RGB (red, green, blue) light source such as an array of laser diodes or LEDs. Such VRD systems 400 typically comprise first and second micro-electromechanical (MEMS) scanning mirrors 404, 404′, the first scanning mirror 404 may act as a frame refresh scanner arranged to scan at a rate of approximately 60 Hz. The second scanning mirror 404′ may act as a raster line scanner, scanning at a rate of several KHz. In this case, the first and/or second MEMS mirrors may be a beam scanner according to embodiments. However, typically the aberrations are highest in the horizontal plane, such that the beam scanner according to embodiments may be the raster line or horizontal scanning mirror 404′. The skilled person will appreciate however, that the beam scanner according to embodiments may be equally implemented on the second scanning mirror 404 acting as a frame refresh or vertical scanner. The first and second micro-electromechanical (MEMS) scanning mirrors may be replaced by a single MEMS tip-tilt mirror which is capable of simultaneous raster line and frame refresh scanning at the desired rates. The MEMS tip-tilt mirror may be a tip-tilt beam scanner comprising the optical baffle as described. An image from the light source 402 may directed onto a holographic optical element (HOE) 406, via exit optics (not illustrated) of the VRD system 400, for reflection to a user eye.

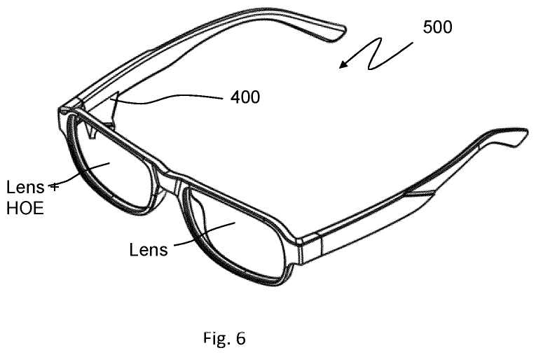

The VRD system 400 described above may be incorporated with an augmented reality display system. As illustrated in FIG. 6, the augmented reality display system may be, for example, a pair of smart glasses 500. The VRD system 400 is typically arranged on one arm of the smart glasses. A HOE is arranged in, or on, a lens of the smart glasses. The VRD system 400 is arranged to project an image beam therefrom onto the lens comprising the holographic optical element so that the image from the VRD system 406 can be relayed to a user's eye. In the context of VRD projectors and smart glass applications the horizontal scan direction may be considered to be the plane defined between a user's nose and temple, or in other words the plane defined between the bridge and one arm of the smart glasses.

As mentioned above geometric aberrations are problematic for virtual retinal display systems utilising holographic optical elements due to their off-axis nature. Any on-axis geometric aberrations will be compounded by off-axis reflections from the holographic optical elements. With the beam scanner according to embodiments it is possible to reduce the geometric aberrations due to off axis reflections from the holographic optical elements because of the asymmetric aperture. That is the light beam reflected by the micro scanning mirror is vignetted asymmetrically because the optical baffle is configured and arranged to partially block the light beam when the micro scanning mirror is at first angular position and fully transmit (pass) the beam when the micro scanning mirror is in the second position and vary the amount of light passing the optical baffle as the micro scanning mirror rotates to intermediate positions.

Particular and preferred aspects of the disclosure are set out in the accompanying independent claims. Combinations of features from the dependent and/or independent claims may be combined as appropriate and not merely as set out in the claims.

The scope of the present disclosure includes any novel feature or combination of features disclosed therein either explicitly or implicitly or any generalisation thereof irrespective of whether or not it relates to the claimed disclosure or mitigate against any or all of the problems addressed by the present disclosure. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

Features which are described in the context of separate embodiments may also be provided in combination in a single embodiment. Conversely, various features which are, for brevity, described in the context of a single embodiment, may also be provided separately or in any suitable sub combination.

The term “comprising” does not exclude other elements or steps, the term “a” or “an” does not exclude a plurality. Reference signs in the claims shall not be construed as limiting the scope of the claims.

1. A beam scanner system for a virtual retinal display comprising:
an optical baffle; and
a micro scanning mirror;
wherein the micro scanning mirror is located on an optical axis of a light source, and configured and arranged to rotate about an axis of rotation to reflectively scan the light beam between a first angular position and a second angular position; and
wherein the optical baffle is positioned with respect to the micro scanning mirror to controllably vignette the light beam as the micro scanning mirror moves between a first angular position and a second angular position.

2. The beam scanner of claim 1, wherein the optical baffle is positioned with respect to the micro scanning mirror to partially obscure the light beam when the micro scanning mirror is at a first angular position and to fully transmit the light beam when the micro scanning mirror is in the second angular position.

3. The beam scanner system of claim 1, wherein the micro scanning mirror is further configured and arranged to scan intermediate angular positions between the first and second angular positions.

4. The beam scanner system of claim 3, wherein the intermediate angular positions partially obscure the light beam and a proportion of the light beam that is obscured is dependent on the angular position of the micro scanning mirror.

5. The beam scanner system of claim 2, wherein the amount of vignetting changes as the micro scanning mirror scans from the first angular position to intermediate angular positions between the first and second angular positions.

6. The beam scanner system of claim 1, wherein the optical baffle comprises first and second distal ends, and wherein the first distal end comprises a longitudinal edge.

7. The beam scanner system of claim 6, wherein the longitudinal edge is linear.

8. The beam scanner system of claim 6, wherein the longitudinal edge is non-linear.

9. The beam scanner system of claim 6 wherein the longitudinal edge comprises a bevelled edge profile, wherein the bevelled edge profile is a knife edge profile.

10. The beam scanner system of claim 1, wherein the optical baffle is coated with an anti-reflection material, the anti-reflection coating comprising an optically absorptive material.

11. The beam scanner system of claim 1, wherein the optical baffle is arranged with respect to the micro scanning mirror such so that between 0 to 80% of the light beam is obscured when the micro scanning mirror scans between the first angular position and the second angular position.

12. The beam scanner system of claim 1, wherein the optical baffle defines an aperture, and wherein the aperture is asymmetric.

13. The beam scanner of claim 1, comprising a plurality of the optical baffles arranged across the plane between the first angular position and the second angular position.

14. The beam scanner of claim 1, further comprising a housing to which the micro scanning mirror is rotatably fixed, wherein the housing comprises an aperture and the optical baffle is arranged at one side of the aperture to define an aperture width.

15. A virtual retinal display projector system comprising the beam scanner system and a light source according to claim 1.

16. The virtual retinal display projector of claim 14, wherein said the light source is an RGB diode laser or LED array and the micro scanning mirror is micro-electromechanical (MEMS) scanning mirror.

17. An augmented reality display system, comprising: the virtual retinal display projector of claim 15, wherein the virtual retinal display projector is configured and arranged to direct the light beam to a holographic optical element (HOE).

18. The augmented reality display system of claim 17, further comprising a pair of smart glasses wherein the holographic optical element is combined with one or more lenses of the smart glasses.
